(19) United States
(12) Patent Application Publication
(10) Pub. No.: US 2015/0127345 A1
(43) Pub. Date: May 7, 2015

(54) Name Based Initiation of Speech Recognition

(71) Applicants: Evan H. Parker, Atherton, CA (US); Michal R. Grabowski, Mountain View, CA (US)

(72) Inventors: Evan H. Parker, Atherton, CA (US); Michal R. Grabowski, Mountain View, CA (US)

(73) Assignee: Google Inc.

(21) Appl. No.: 13/249,303

(22) Filed: Sep. 30, 2011

Related U.S. Application Data
(63) Continuation of application No. 12/981,749, filed on Dec. 30, 2010.

(51) Int. Cl. G10L 25/48; G10L 15/04

(52) U.S. Cl. CPC G10L 25/48
USPC 704/251; 704/E15.001

(57) ABSTRACT

A computer-implemented method includes listening for audio name information indicative of a name of a computer, with the computer configured to listen for the audio name information in a first power mode that promotes a conservation of power; detecting the audio name information indicative of the name of the computer; after detection of the audio name information, switching to a second power mode that promotes a performance of speech recognition; receiving audio command information; and performing speech recognition on the audio command information.

### CROSS-REFERENCE TO RELATED APPLICATIONS

This application is a continuation of U.S. patent application Ser. No. 12/981,749, filed Dec. 30, 2010, which is incorporated herein in its entirety.

### TECHNICAL FIELD

This document relates generally to name based initiation of speech recognition.

### BACKGROUND

A speech recognition system converts speech into text. The speech recognition system may include a microphone to receive and to capture speech. For example, when a person speaks, a microphone converts an analog signal of the speech into digital data that the speech recognition system may analyze. From the digital data, the speech recognition system generates phonemes (e.g., linguistic units) by applying a Fourier Transform to a waveform of the digital data.

The speech recognition system may convert the phonemes into words and into sentences, for example, using a Hidden Markov Model (“HMM”), as described in Juang et al., “Recent Developments In the Application of Hidden Markov Models to Speaker-Independent Isolated Word Recognition”, PROC. IEEE ICASSP, Mar. 1985, pp. 9-12.

Generally, a speech recognition system may be in an “off” state, in which speech recognition is not performed. The speech recognition system may also be in an “on” state, in which speech recognition is performed. The speech recognition system moves from the off state to the on state by detecting a non-audio interaction that indicates that the speech recognition system should begin performing speech recognition. A non-audio interaction includes a physical interaction with the system, including, e.g., a touch of a button on the system, a selection of a link on the system, and so forth.

In an example, the SHAZAM service uses a short sample of music to identify a song. In particular, a user may use the SHAZAM service by downloading a SHAZAM application onto a mobile device. From the application, the user selects a button (in a graphical user interface displayed on the mobile device) to indicate that the user is instructing the SHAZAM service to identify a song. The user then holds the mobile device's microphone to a speaker that is playing the song. The SHAZAM service identifies the song and sends to the user's mobile device information related to the song, including, e.g., artist information, a link to purchase the album, and so forth.

### SUMMARY

In one aspect of the present disclosure, a computer-implemented method includes listening for audio name information indicative of a name of a computer, with the computer configured to listen for the audio name information in a first power mode that promotes a conservation of power; detecting the audio name information indicative of the name of the computer; after detection of the audio name information, switching to a second power mode that promotes a performance of speech recognition; receiving audio command information; and performing speech recognition on the audio command information.

Implementations of the disclosure may include one or more of the following features. In some implementations, the method also includes performing one or more actions that are specified by the audio command information. The performing the one or more actions includes sending the audio command information to a server; and receiving, from the server, one or more action execution instructions including information indicative of one or more commands to be executed by the computer.

In other implementations, the method includes training the computer to detect the audio name information, wherein training includes: receiving the audio name information; storing the audio name information in a set of information indicative of the name of the computer; receiving audio training information; determining that the audio training information corresponds to the audio name information; generating an audio notification that the audio training information corresponds to the audio name information; receiving validation information specifying whether the computer has correctly determined that the audio training information corresponds to the audio name information; and updating, based on the validation information, the set of information indicative of the name of the computer.

In still other implementations, the method includes after detection of the audio name information, generating an audio acknowledgment of detection of the audio name information. The audio name information includes first audio name information, and the method further includes: receiving second audio name information, with the second audio name information corresponding to an initial naming of the computer; storing information indicative of a voice of a user that sent the second audio name information; and determining that a voice of a user speaking the first audio name information matches the voice of the user that sent the second audio name information. In other implementations, the second mode includes a conversation mode.

In another aspect of the disclosure, one or more machine-readable media are configured to store instructions that are executable by one or more processing devices to perform functions including listening for audio name information indicative of a name of a computer, with the computer configured to listen for the audio name information in a first power mode that promotes a conservation of power; detecting the audio name information indicative of the name of the computer; after detection of the audio name information, switching to a second power mode that promotes a performance of speech recognition; receiving audio command information; and performing speech recognition on the audio command information. Implementations of this aspect of the present disclosure can include one or more of the foregoing features.

In still another aspect of the disclosure, an electronic system includes one or more processing devices; and one or more machine-readable media configured to store instructions that are executable by the one or more processing devices to perform functions including: listening for audio name information indicative of a name of a computer, with the computer configured to listen for the audio name information in a first power mode that promotes a conservation of power; detecting the audio name information indicative of the name of the computer; after detection of the audio name information, switching to a second power mode that promotes a performance of speech recognition; receiving audio command information; and performing speech recognition on the audio command information. Implementations of this aspect of the present disclosure can include one or more of the foregoing features.

In yet another aspect of the disclosure an electronic system includes means for listening for audio name information indicative of a name of a computer, with the computer configured to listen for the audio name information in a first power mode that promotes a conservation of power; detecting the audio name information indicative of the name of the computer; after detection of the audio name information, switching to a second power mode that promotes a performance of speech recognition; receiving audio command information; and performing speech recognition on the audio command information. Implementations of this aspect of the present disclosure can include one or more of the foregoing features.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### DESCRIPTION OF DRAWINGS

FIG. 1 is a conceptual diagram of a system that operates in conversation mode following detection of an audio interaction.

FIG. 2 is a block diagram of components of the system that operates in conversation mode following detection of an audio interaction.

FIG. 3 is a flow chart of a process of training a client device to recognize a name associated with the client device.

FIG. 4 is a flow chart showing a process for detecting an audio interaction that causes the system to operate in conversation mode.

FIG. 5 shows an example of a computer device and a mobile computer device that can be used to implement the techniques described herein.

Like reference symbols in the various drawings indicate like elements.

### DETAILED DESCRIPTION

Described herein is a system that is configured to detect an audio interaction that triggers the system to emulate a conversation with a user of the system. Generally, an audio interaction includes an audio communication (e.g., speech) that specifies a desire of the user to interact with the system. In an example, the audio interaction includes addressing the system by a pre-defined name (e.g., “hey, bob the computer”), asking the system a question (e.g., “please give me directions to Boston”), and so forth.

After detection of the audio interaction, the system is further configured to emulate a “conversation” with the user. Generally, a conversation includes a process in which the system performs speech recognition on speech received into the system and generates audio information that is responsive to the received speech. Generally, audio information includes information that relates to the sending and/or to the receiving of sound. For example, in response to receiving speech of “please give me directions to Boston,” the system may generate the following audio information: “Yes, sir, let me retrieve the directions.” In order for the system to emulate a conversation with the user, the system operates in a particular mode, in which the system's speech recognition and speech generation processes are implemented. This particular mode may be referred to as a “conversation mode.”

To promote the system's ability to detect an audio interaction that triggers the system to operate in conversation mode, the system includes a microphone that remains turned on to capture speech of a user of the system. Because the microphone remains turned on to receive the audio interaction, the system is configured to operate in conversation mode without receiving a physical interaction with the system. For example, through the microphone, the system is configured to receive the audio information of “please give me directions to Boston,” without a user having to select a link or a button indicating that the user is seeking directions to Boston.

In an example, the system is configured to continuously operate in conversation mode to perform speech recognition on a flow of speech received into the system by a microphone. The system processes the received speech to determine if a portion and/or all of the received speech includes an audio interaction that is directed to the system (e.g., “hey, bob the computer,” “please give me directions to Boston,” and so forth). In an example, none of the received speech includes an audio interaction that is directed to the system. In this example, the user may be speaking to a friend and the conversation may be captured and processed by the system, when in fact none of the speech is directed towards the system.

Rather than operating in conversation mode and performing speech recognition on a flow of speech that may not be directed towards the system, the system may also be configured to operate in conversation mode after detection of a number of pre-defined audio interactions, including, e.g., after receipt of “audio name information.” Generally, audio name information includes information specifying a name of the system. In an example, a user assigns the system a name by using the microphone to record the audio name information, which is saved by the system. Audio name information may include a proper name (e.g., “Emily” or “Bob”), a phrase (e.g., “The quick brown fox jumps over the lazy dog”), a series of clicks and/or beeps, and any other sounds that a user may record via the system.

As previously addressed, the audio name information may include a series of clicks, for example, clicking sounds that are made by user 110 with the tongue of user 110. For example, the series of clicks may emulate the sound that a rider of a horse makes to the horse, for example to communicate with the horse. The series of clicks may also include a sequence of evenly spaced clicks.

When the audio name information includes a series of clicks, name recognition application 108 consumes very little processing power to recognize the clicks, for example, less processing power than is required for name recognition application 108 to recognize a name that is associated with words, phrases, sentences, and so forth. Name recognition application 108 consumes less processing power in recognizing a series of clicks, because the sounds associated with the clicks are simpler than the sounds associated with words, and therefore the sounds associated with clicks are easier for name recognition application 108 to recognize.

In an example, name recognition application 108 does not need to generate phonemes for a series of clicks and therefore does not need to apply a Fourier Transform to a waveform representing digital data of the series of clicks. Because name recognition application 108 may recognize the series of clicks without applying the Fourier Transform, name recognition application 108 consumes a reduced amount of processing power in recognizing the series of clicks.

By configuring the system to listen for and to detect the audio name information as a trigger to operate in conversation mode, the system promotes a conservation of power and system resources. For example, when the system is configured to detect name information 107, the system generates phonemes for received audio information 112 by applying a Fourier Transform to a waveform of the received audio information 112. Rather than converting all of the generated phonemes into words and into sentences, for example, using HMM, name recognition application 108 only needs to compare the generated phonemes to name information 107 and/or a phoneme associated with name information 107. By only comparing the generated phonemes to name information 107, the system consumes less processing power and resources than would be otherwise consumed, for example, by converting all of the generated phonemes into words and into sentences, as further described in the following examples.

Because the microphone remains in a powered on state, if the system processes all received speech to determine speech directed towards the system, the system may consume numerous resources in a limited resource environment, including, e.g., in a mobile computing environment. By configuring the system to operate in conversation mode after detection of audio name information, the system may consume fewer resources by reducing power usage of the system. In particular, the system consumes less processing power to identify a name in a flow of speech than to determine a meaning for an entire flow of speech. There are numerous other ways that the system may reduce power usage, which are described in further detail below.

In an example, the user assigns the system the name of “Bob.” In this example, the user may speak the following words: “Hey Bob.” When the system detects the audio name information, namely the word “Bob,” the system enters into conversation mode, in which the system is configured to perform speech recognition on the flow of speech received by the system. In conversation mode, the system is configured to emulate a conversation with the user. An example conversation is provided in the below Table 1:

TABLE 1

User: Hey Bob
Computer: Yes
User: Navigate to San Francisco
Computer: Will do . . . navigating to San Francisco
Computer: Here are the directions to San
Francisco. Take Route 90 for half a mile and
then turn left onto San Francisco Boulevard.

As described in Table 1, the system responds to the audio name information of “Hey Bob” by generating an audio acknowledgement of “Yes.” Generally, an audio acknowledgement includes information notifying the user that the system has received and processed the speech of the user. In response to the audio name information, the system is configured to operate in conversation mode to interpret the speech of “Navigate to San Francisco,” to generate the additional audio acknowledgement of “Will do . . . navigating to San Francisco,” and to generate audio information that provides the user with the directions to San Francisco.

In an example, the system listens for the audio name information at pre-defined time intervals, including, e.g., every second, every five seconds, and so forth. The system may also periodically and/or continuously listen for the audio name information. By periodically and/or continuously listening for audio name information, the system is configured to respond to the audio name information, without receiving a physical interaction from a user.

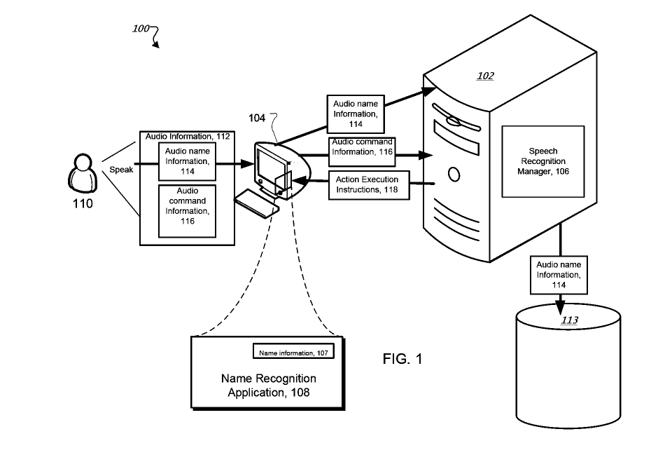

FIG. 1 is a conceptual diagram of system 100 that operates in conversation mode following detection of an audio interaction. System 100 includes server 102 and client device 104. User 110 of system 100 speaks various types of audio information 112 that is received by a microphone (not shown) of client device 104. Client device 104 includes name recognition application 108. Name recognition application 108 includes name information 107 specifying a name for client device 104. In an example, user 110 uses a microphone (not shown) to record a name for client device 104. The recorded name is stored on client device 104 as name information 107. Name recognition application 108 is configured to determine whether audio information 112 “corresponds” to name information 107 of client device 104. Generally, correspondence includes a match or a similarity (or any combination thereof) between two items of information.

In the example of FIG. 1, audio information 112 includes audio name information 114 and audio command information 116, as described in further detail below. Audio name information 114 includes information corresponding to name information 107. In an example, client device 104 sends audio name information 114 to server 102 for storage by data repository 113 associated with server 102.

After receipt of and recognition of audio name information 114, name recognition application 108 is configured to operate in conversation mode. In conversation mode, name recognition application 108 processes additional, received audio information, namely, audio command information 116. Audio command information 116 includes information specifying a command to be performed by client device 104. Name recognition application 108 may operate in conversation mode by sending audio command information 116 to server 102 for processing, as described in further detail below.

In an example, audio command information 116 may include a request for directions to a geographic location, a request to place a call, a request to perform an online search, a request to transcribe an audio phrase, a request to provide an answer to a question, and so forth. In the example of FIG. 1, name recognition application 108 receives audio command information 116 and sends audio command information 116 to server 102, which is configured to perform speech recognition on audio command information 116.

Server 102 receives audio command information 116. Server 102 includes speech recognition manager 106, which is configured to perform speech recognition on audio command information 116 received from client device 104. Based on the performed speech recognition, speech recognition manager 106 generates action execution instructions 118. Action execution instructions 118 include information specifying one or more actions to be performed by client 104. Server 102 sends action execution instructions 118 to client device 104. Following receipt of action execution instructions 118, client device 104 is configured to perform the actions specified by action execution instructions 118.

In an example, audio command information 116 includes a request to make a telephone call using a telephone number stored in an address book of client device 104. In this example, action execution instructions 118 include instructions for client device 104 to place a telephone call using the telephone number stored in an address book of client device 104. In another example, audio command information 116 includes a request for directions to a geographic location. In this example, action execution instructions 118 include information specifying the directions and instructions for client device 104 to render a visual representation of the directions on a display of client device 104.

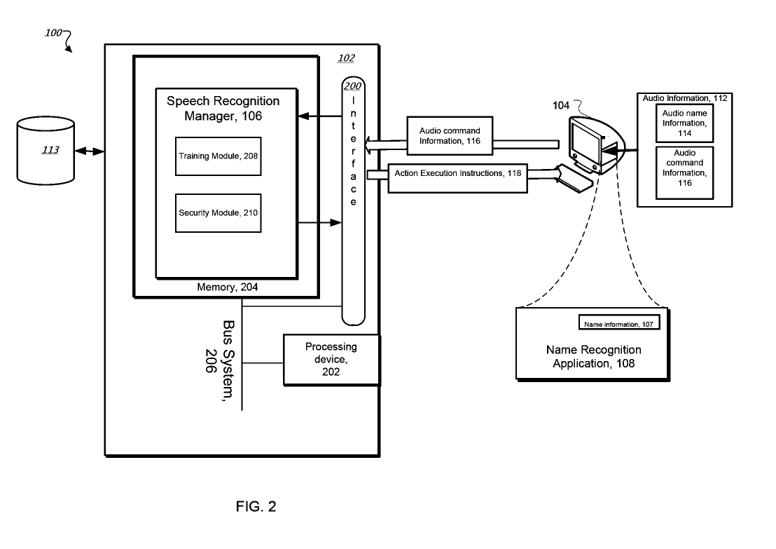

FIG. 2 is a block diagram of components of system 100 that operates in conversation mode following detection of an audio interaction. In FIG. 2, user 110 is not shown.

Client device 104 can be any sort of computing device capable of taking input from user 110 (FIG. 1) and communicating over a network (not shown) with server 102 and/or with other client devices. For example, client device 104 can be a mobile device, a desktop computer, a laptop, a tablet, a cell phone, a personal digital assistant (“PDA”), a server, an embedded computing system, and so forth.

Server 102 can be any of a variety of computing devices capable of receiving information, such as a server, a distributed computing system, a desktop computer, a laptop, a cell phone, a rack-mounted server, and so forth. Server 102 may be a single server or a group of servers that are at a same location or at different locations.

Server 102 can receive information from client device 104 via input/output (“I/O”) interface 200. I/O interface 200 can be any type of interface capable of receiving information over a network, such as an Ethernet interface, a wireless networking interface, a fiber-optic networking interface, a modem, and so forth. Server 102 also includes a processing device 202 and memory 204. A bus system 206, including, for example, a data bus and a motherboard, can be used to establish and to control data communication between the components of server 102.

Processing device 202 may include one or more microprocessors. Generally, processing device 202 may include any appropriate processor and/or logic that is capable of receiving and storing data, and of communicating over a network (not shown). Memory 204 can include a hard drive and a random access memory storage device, such as a dynamic random access memory, or other types of non-transitory machine-readable storage devices. As shown in FIG. 2, memory 204 stores computer programs that are executable by processing device 202. Among these computer programs are speech recognition manager 106, training module 208, and security module 210, each of which are described in further detail below.

Security module 210 is configured to verify that user 110 (FIG. 1) is authorized to access client device 104. Security module 210 may be configured to retrieve audio name information 114 and name information 107 from client device 104 to promote authentication of user 110 of client device 104. In particular, name information 107 may be used as a form of security for accessing client device 104. A pre-defined level of correspondence between name information 107 and audio name information 114 may be used to vary the level of security.

In an example, security module 210 may be configured to authenticate user 110 based on “spoken name” authentication. Generally, spoken name authentication includes authenticating user 110 based on a correspondence between name information 107 and audio name information 114 and based on a correspondence between the voice of user 110 and the voice of the user that recorded name information 107.

In an example, spoken name authentication includes configuring client device 104 to respond to its name when spoken by multiple users of system 100. In another example, client device 104 may be configured to respond to its name when spoken by the user that originally recorded name information 107. In this example, security module 210 uses a voice similarity matching process to determine whether user 110 corresponds to the user who originally recorded name information 107.

Security module 210 may also be configured to prompt user 110 with a security challenge prior to user 110 being granted access to issue commands to client device 104. Generally, a security challenge includes a prompt for user 110 to provide authenticating information, including, e.g., a password, a personal identification number (“PIN”), an identifying gesture, and so forth.

In an example, a level of security provided by a spoken name authentication may be lower (or higher) than a level of security provided by a security challenge, or vice versa. In this example, the access to client device 104 that is granted to user 110 based on spoken name authentication may be restricted, for example, by allowing user 110 to enter a conversation with client device 104 but restricting the set of commands that client device 104 will execute from the conversation. Security module 210 is also configured to support multiple user accounts on client device 104, for example, by storing name information associated with each user.

Training module 208 is configured to train client device 104 to recognize its name as specified by name information 107. To train client device 104, user 110 speaks various names into the microphone of client device 104. Client device 104 sends the various spoken names to training module 208. Training module 208 performs speech recognition on the various spoken names. When training module 208 detects a spoken name corresponding to name information 107, training module 208 generates an audio acknowledgement that includes information specifying that training module 208 has detected that user 110 has spoken the name of client device 104. Based on the audio acknowledgement, user 110 provides feedback to training module 208 specifying whether training module 208 correctly identified the name of client device 104.

When training module 208 has incorrectly detected that user 110 has spoken the name of client device 104, user 110 issues a command to training module 208 indicating that the spoken name was incorrect. Based on the issued command, training module 208 trains name recognition application 108 to not identify the spoken name as name information 107. When training module 208 has correctly detected that user 110 has spoken the name of client device 104, user 110 issues a command to training module 208 indicating that the spoken name was correct. Based on the issued command, training module 208 trains name recognition application 108 to identify the spoken name as name information 107.

Training module 208 is also configured to train client device 104 to recognize the name of client device 104 through a conversation with user 110. In an example, user 110 speaks information that does not correspond to the name of client device 104. In this example, training module 208 incorrectly detects name information 107 in the spoken information. Based on the incorrectly detected name information 107, training module 208 generates an audio acknowledgement, indicating that training module 208 detected name information 107 in audio information 112. In this example, user 110 may issue to client device 104 a command indicating that training module 208 incorrectly detected name information 107 in audio information 112 (e.g., “No, I did not say the name ‘Bob.’ I said ‘frog,’ which is not your name.). Based on the command, training module 208 is configured to update a set of information associated with name information 107 to promote an ability of training module 208 to recognize its name.

In another example, user 110 addresses client device 104 with the correct name but client device 104 does not respond with an audio acknowledgment indicating that user 110 has addressed the computer. In this example, user 110 trains client device 104 to recognize its name by addressing client device 104 with the same name again (perhaps in a clearer or in a louder voice). When client device 104 correctly responds to the spoken name, user 110 issues to client device 104 a command indicating that client device 104 failed to recognize the name of client device 104 the first time.

In an example, speech recognition manager 106 may be configured to generate a graphical user interface. The graphical user information may include a visual representation of a conversation between user 110 and client device 104, for example, when the graphical user interface is rendered on a display of client device 104. In an example, speech recognition manager 106 generates a graphical user interface that includes a textual representation of the conversation between user 110 and client device 104. In another example, speech recognition manager 106 is also configured to display a visual notification (e.g., a graphic, flashing words, blinking lights, and so forth) of when client device 104 operates in conversation mode.

Name recognition manager 108 may also be configured to customize a voice and/or a personality of client device 104, for example, based on input from user 110. In an example, user 110 downloads to client device 104 information specifying different voices and/or personalities for client device 104 that configure client device 104 to speak in a pre-defined voice, including, e.g., the voice of an English butler, the voice of a famous actor, the voice of a famous athlete, and so forth. An example conversation in which client device 104 is configured with an English butler personality is provided in the below Table 2:

TABLE 2

CONVERSATION 1
User: Hollingsworth
Computer: At your service, sire.
User: Never mind
Computer: As you wish, sire.
CONVERSATION 2
User: Hollingsworth
Computer: Yes, sire?
User: Never mind
Computer: Of course, sire.
CONVERSATION 3
User: Hollingsworth
Computer: What now, sire?
User: Never mind
Computer: Will you please make up your mind, sire?!?!

As described in Table 2, user 110 engages in three conversations with client device 104, each time initiating the conversation with client device 104 by speaking the name “Hollingsworth.” In the example of the first conversation, client device 104 responds to audio name information of “Hollingsworth” by generating the audio acknowledgement of “At your service, sire.” In response to the audio name information of “Hollingsworth,” client device 104 is further configured to operate in conversation mode to interpret the speech of “never mind” and to generate the additional audio acknowledgement of “As you wish, sire.” Client device 104 is further configured to similarly respond for the second and the third conversations.

Name recognition manager 108 may also be configured to listen for audio information received from multiple microphones associated with client device 104. For example, client device 104 may be associated with multiple microphones when client device 104 is configured for use by multiple users, including, e.g., in a gaming environment. In this example, name recognition manager 108 listens for its name on multiple microphones associated with client device 104. When name recognition manager 108 receives audio information 112 indicative of a name of client device 104 from one of the microphones, name recognition manager 108 identifies the microphone that received the name information. To promote an ability of name recognition manager 108 to engage in a conversion with a user that is speaking into the identified microphone, name recognition manager 108 filters out noise received from the other microphones. In an example, name recognition manager 108 implements noise-cancellation algorithms to filter out sound received from the other microphones.

In this example, name recognition manager implements an active noise cancellation (“ANC”) technique, in which ambient noise is reduced and/or eliminated. Additionally, ANC may be used to suppress background noise, intermittent sounds and echoes that are received by the other microphones associated with client device 104. ANC may also be used by system 100 to automatically adjust voice volume and equalization to adapt to local noise interference, for example during a conversation between client device 104 and user 110. To implement ANC, at least two microphones are required, one microphone for detecting the name information and another microphone for receiving and/or detecting other noise, including, e.g., background noise, ambient noise, and so forth.

To implement ANC, server 102 may include dedicated noise-suppression integrated circuits. To enhance a performance of ANC, the microphone of system 100 may include a Micro-electro-mechanical systems (MEMS) microphone. A MEMS microphone may be used to promote an enhanced performance of the microphone in terms of sensitivity to audio information, an increase in signal-to-noise ratio and an increase in the suitability of the microphone for use with digital signal processors that may be included in system 100 to implement ANC.

In another example, name recognition manager 108 marks audio information received from the other microphones as noise and does not perform speech recognition on the noise received from the other microphones.

Name recognition manager 108 is configured to engage in conversations with multiple, different users, for example, at different times. In this example, client device 104 stores information indicative of multiple user accounts. For each of the multiple user accounts, a user has specified a name for client device 104. When the specified name is detected by name recognition manager 108, the user that has spoken the specified name is granted access to engage in a conversation with client device 104.

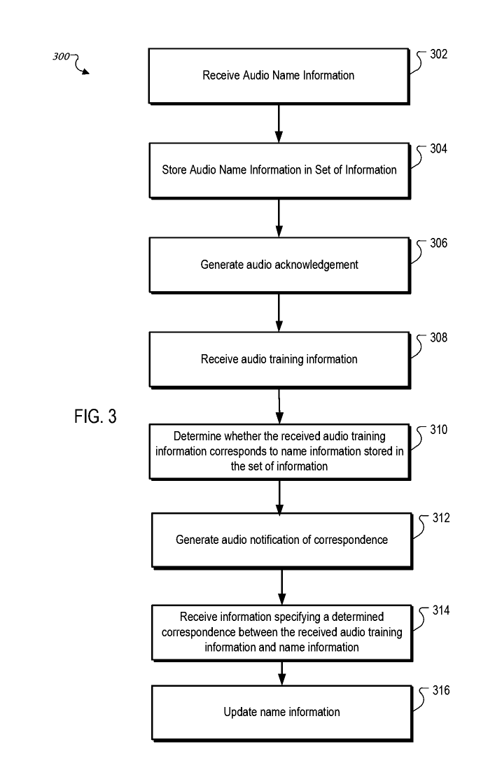

FIG. 3 is a flow chart of process 300 of training client device 104 to recognize a name associated with client device 104. In operation, training module 208 receives (302) audio name information. Training module 208 may receive the audio name information through a communication channel that is established with client device 104. Training module 208 stores (304) the audio name information in a set of information specifying the name of client device 104. In an example, the set of information may reside on a data repository (not shown) that is included in system 100. The set of information may include a copy of name information 107 (FIG. 1), for example, if name information is stored locally on client device 104.

Training module 208 generates (306) an audio acknowledgement of the received audio name information. In an example, training module 208 generates an audio acknowledgement that when rendered on a microphone associated with client device 104 notifies user 110 of the received audio name information.

Training module 208 also receives (308) audio training information from client device 104. Generally, audio training information includes information that is used to train name recognition application 108 to recognize a name that has been assigned to client device 104. In an example, the audio training information may include a list of names (e.g., “Bob,” “Frank,” “Hank,” and so forth). Training module 208 determines (310) whether the received audio training information corresponds to name information 107 stored in the set of information. Based on a determined correspondence, training module 208 generates (312) an audio notification of correspondence (e.g., “Yes, you spoke the name of the computer,” “No, you did not speak the name of the computer,” and so forth). In an example, the audio notification of correspondence includes information specifying that the received audio training information corresponds to name information 107 stored in the set of information (e.g., “Yes, you spoke the name of the computer”). In another example, the audio notification of correspondence includes information specifying that the received audio training information fails to correspond to name information 107 stored in the set of information (e.g., “No, you did not speak the name of the computer”).

Training module 208 receives (314), from user 110, information specifying a correctness of the determined correspondence between the received audio training information and name information 107. For example, if training module 208 recognized that received audio training information corresponds to name information 107, user 110 may speak the words “Yes, that is correct” into a microphone to specify the correctness of the determined correspondence between the received audio training information and name information 107. In another example, when training module 208 recognizes that received audio training information corresponds to name information 107, user 110 may select a button, a link, and/or a selectable area of a graphical user interface displayed on client device 104 to specify the correctness of the determined correspondence between the received audio training information and name information 107.

Based on the received information specifying the correctness of the determined correspondence, training module 208 updates (316) name information 107 in name recognition application 108 with information specifying whether the determined correspondence was correct or incorrect. In another example, training module 208 may update the set of information stored in the data repository with the information specifying whether the determined correspondence was correct or incorrect.

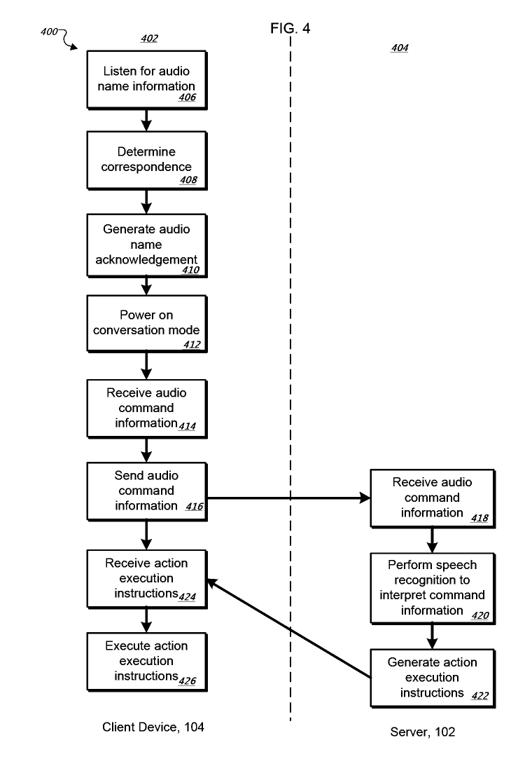

FIG. 4 is a flowchart showing a process 400 for detecting an audio interaction that causes system 100 to operate in conversation mode. In FIG. 4, process 400 is split into a left part 402, which is performed on client device 104, and a right part 104, which is performed on server 102 (e.g., the left part, or a portion thereof, is performed by name recognition application 108, and the right part, or a portion thereof, is performed by speech recognition manager 106).

In operation, name recognition application 108 listens (406) for name information 107. Name recognition application 108 receives (not shown) audio name information 114 and determines (408) a correspondence between audio name information 114 and name information 107. As previously discussed, because name recognition application 108 only performs speech recognition to determine whether audio information 112 corresponds to name information 107, name recognition application 108 consumes a reduced amount of processing power than would be consumed if name recognition application 108 recognized speech on an entire flow of received audio information 112. That is, name recognition application 108 consumes less processing power in recognizing name information 107, because a single name is simpler to recognize than an entire phrase and/or sentence.

After determination of the correspondence between audio name information 114 and name information 107, name recognition application 108 generates (410) audio name acknowledgement. Name recognition application 108 powers on (412) conversation mode, for example, to begin performing speech recognition on audio command information 116 that is received by a microphone associated with client device 104. Name recognition application 108 receives (414) audio command information 116, for example, from user 110 of client device 104. Name recognition application 108 generates (not shown) an audio acknowledgement to notify user 110 of receipt of audio command information 116 by client device 104. Name recognition application 108 sends (416) the audio command information 116 to speech recognition manager 106 on server 102.

In the example of FIG. 4, audio command information 116 is processed by speech recognition manager 106 on server 102. Due to the time required for server 102 to process audio command information 116, a time lag may exist from when user 110 speaks audio command information 116 to when user 110 receives action execution instructions 118. In this example, the audio command acknowledgement provides user 110 with an assurance that the audio command information 116 is being processed.

Speech recognition manager 106 receives (418) audio command information 116 and performs (420) speech recognition to interpret audio command information 116. Based on an interpretation of audio command information 116, speech recognition manager 106 generates (422) action execution instructions 118. Speech recognition manager 106 sends (not shown) action execution instructions 118 to client device 104. Client device 104 receives (424) action execution instructions 118 and executes (426) the actions that are specified in action execution instructions 118. In a variation of FIG. 4, actions 418, 420, 422 (or any combination thereof) may be performed on client device 104.

Using the techniques described herein, a system that includes a microphone remains in a powered on state to detect audio name information associated with the system. Detection of the audio name information causes the system to enter a conversation mode, in which speech recognition is performed on a flow of audio information received into the system. Based on the received audio information, the system also performs speech generation to emulate a conversation between a user of the system and the system.

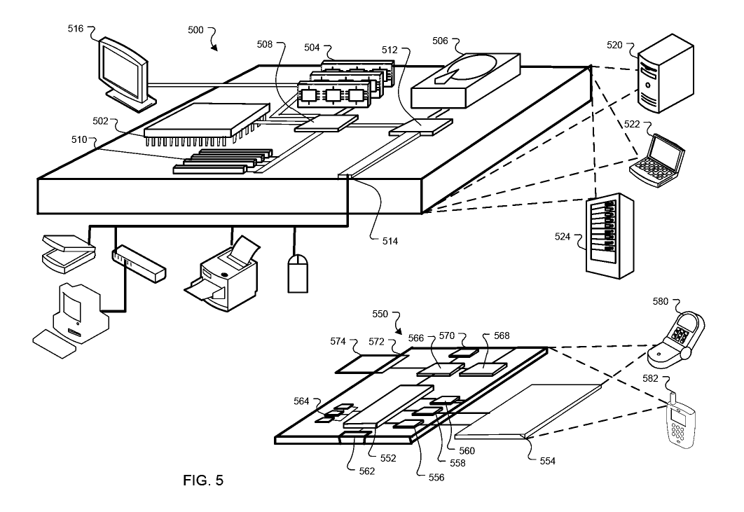

FIG. 5 shows an example of a computer device 500 and a mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 704, 706, 708, 710, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is an example only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, and so forth) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the processes and techniques described herein. In an example, there are numerous other ways that the system may minimize power usage, including, e.g., performing name processing locally on a client device, performing name processing in dedicated hardware (rather than on a general purpose central processing unit), reducing a frequency at which incoming sound is processed for name recognition, processing incoming sound for name recognition when sound level is above a frequency threshold, varying the frequency threshold based on factors (e.g., time of day, input from other sensors, calendar entries, battery level, and so forth) that may predict the likelihood that the system will be addressed so as to trade off effectively between a system recall rate and power usage, and so forth.

In an example, performance of name recognition locally on client device 104 (as opposed to going over a network to server 102) has multiple advantages, including, e.g., a faster name recognition speed, a reduction in consumption of power in system 100, and so forth. In this example, client device 104 acknowledges receipt of the command the user gives (e.g., the command being the second utterance by the user after name acknowledgement by client device 104), for example, immediately after receiving the command and before client device 104 has processed the command either locally or by sending the command over a network to a server for processing. By quickly acknowledging receipt of the command, client device 104 is able to process the command, which may take a few seconds, without the user being unsure as to whether client device 104 received the command.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Although a few implementations have been described in detail above, other modifications are possible. Moreover, other mechanisms for editing voice may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations not specifically described herein are also within the scope of the following claims.

1. A method comprising:
determining, by a client computing device, that audio name information indicative of a name of the client computing device is included in a first audio input, with the client computing device configured to detect the audio name information in a first power mode in which speech recognition is not completed on audio inputs;
generating, by the client computing device in the first power mode that differs from a second power mode for receiving audio command information, an acknowledgment to notify a user of the client computing device of detection of the audio name information, wherein, in the second power mode, speech recognition is completed on audio inputs;
in response to and following generation of the acknowledgement, switching the client computing device to the second power mode;
receiving, in the second power mode, audio command information;
transmitting the audio command information to a server computing device; and
receiving, from the server computing device, a response to the audio command information, wherein the acknowledgment differs from the response.

2. The method of claim 1, further comprising:
performing one or more actions that are specified by the audio command information.

3. The method of claim 1, wherein the response comprises information indicative of one or more commands to be executed by the client computing device.

4. The method of claim 1, wherein the audio name information is stored in a data repository, and wherein the method further comprises:
training the client computing device to detect the audio name information by performing operations comprising:
receiving audio training information to train the client computing device to detect the audio name information;
retrieving, from the data repository, the audio name information that is stored in the data repository;
determining that the audio training information corresponds to the audio name information that is stored in the data repository;
rendering, for a user of the client computing device, an audio notification that notifies the user that the audio training information corresponds to the audio name information;
receiving, in response to rendering of the audio notification, feedback information specifying that the client computing device has correctly determined that the audio training information corresponds to the audio name information; and
updating, based on the feedback information, the set of audio name information indicative of the name of the client computing device with the audio training information.

5. The method of claim 1, wherein generating comprises:
after detection of the audio name information, generating the acknowledgment.

6. The method of claim 1, wherein the audio name information comprises first audio name information, and wherein the method further comprises:
receiving second audio name information, with the second audio name information corresponding to an initial naming of the client computing device;
storing information indicative of a voice of a user that sent the second audio name information; and
determining that a voice of a user speaking the first audio name information matches the voice of the user that sent the second audio name information.

7. The method of claim 1, wherein the client computing device is configured to consume less power in the first power mode than in the second power mode.

8. One or more non-transitory machine-readable media storing instructions that are executable by one or more processing devices of a client computing device to perform operations comprising:
determining, by the client computing device, that audio name information indicative of a name of the client computing device is included in a first audio input, with the client computing device configured to detect the audio name information in a first power mode in which speech recognition is not completed on audio inputs;
generating, in the first power mode that differs from a second power mode for receiving audio command information, an acknowledgment to notify a user of the client computing device of detection of the audio name information, wherein, in the second power mode, speech recognition is completed on audio inputs;
in response to and following generation of the acknowledgement, switching the client computing device to the second power mode;
receiving, in the second power mode, audio command information;
transmitting the audio command information to a server computing device; and
receiving, from the server computing device, a response to the audio command information, wherein the acknowledgment differs from the response.

9. The one or more non-transitory machine-readable media of claim 8, wherein the operations further comprise:
performing one or more actions that are specified by the audio command information.

10. The one or more non-transitory machine-readable media of claim 8, wherein the response comprises information indicative of one or more commands to be executed by the client computing device.

11. The one or more non-transitory machine-readable media of claim 8, wherein the audio name information is stored in a data repository, and wherein the operations further comprise:
training the client computing device to detect the audio name information by performing operations comprising:
receiving audio training information to train the client computing device to detect the audio name information;
retrieving, from the data repository, the audio name information that is stored in the data repository;
determining that the audio training information corresponds to the audio name information that is stored in the data repository;
rendering, for a user of the client computing device, an audio notification that notifies the user that the audio training information corresponds to the audio name information;
receiving in response to rendering of the audio notification, feedback information specifying that the client computing device has correctly determined that the audio training information corresponds to the audio name information; and
updating, based on the feedback information, the audio name information indicative of the name of the client computing device with the audio training information.

12. The one or more non-transitory machine-readable media of claim 8, wherein generating comprises:
after detection of the audio name information, generating the acknowledgment.

13. The one or more non-transitory machine-readable media of claim 8, wherein the audio name information comprises first audio name information, and wherein the operations further comprise:
receiving second audio name information, with the second audio name information corresponding to an initial naming of the client computing device;
storing information indicative of a voice of a user that sent the second audio name information; and
determining that a voice of a user speaking the first audio name information matches the voice of the user that sent the second audio name information.

14. The one or more non-transitory machine-readable media of claim 8, wherein the client computing device is configured to consume less power in the first power mode than in the second power mode.

15. An electronic system comprising:
one or more processing devices; and
one or more machine-readable media storing instructions that are executable by the one or more processing devices to perform operations comprising:
determining, by a client computing device, that audio name information indicative of a name of the client computing device is included in first audio input, with the client computing device configured to detect the audio name information in a first power mode in which speech recognition is not completed on audio inputs;
generating, in the first power mode that differs from a second power mode for receiving audio command information, an acknowledgment to notify a user of the client computing device of detection of the audio name information, wherein, in the second power mode, speech recognition is completed on audio inputs;
in response to and following generation of the acknowledgement, switching the client computing device to the second power mode;
receiving, in the second power mode, audio command information;
transmitting the audio command information to a server computing device; and
receiving, from the server computing device, a response to the audio command information, wherein the acknowledgment differs from the response.

16. The electronic system of claim 15, wherein the operations further comprise:
performing one or more actions that are specified by the audio command information.

17. The electronic system of claim 15, wherein the response comprises:
information indicative of one or more commands to be executed by the client computing device.

18. The electronic system of claim 15, wherein the audio name information is stored in a data repository, and wherein the operations further comprise:
training the client computing device to detect the audio name information by performing operations comprising:
receiving audio training information to train the client computing device to detect the audio name information;
retrieving, from the data repository, the audio name information that is stored in the data repository;
determining that the audio training information corresponds to the audio name information that is stored in the data repository;
rendering, for a user of the client computing device, an audio notification that notifies the user that the audio training information corresponds to the audio name information;
receiving in response to rendering of the audio notification, feedback information specifying that the client computing device has correctly determined that the audio training information corresponds to the audio name information; and
updating, based on the feedback information, the audio name information indicative of the name of the client computing device with the audio training information.

19. The electronic system of claim 15, wherein the audio name information comprises first audio name information, and wherein the operations further comprise:
receiving second audio name information, with the second audio name information corresponding to an initial naming of the client computing device;
storing information indicative of a voice of a user that sent the second audio name information; and
determining that a voice of a user speaking the first audio name information matches the voice of the user that sent the second audio name information.

20. (canceled)

21. The method of claim 1, wherein the client computing device configured to detect the audio name information in a first power mode in which speech recognition is not completed on audio inputs, comprises:
a client computing device that is configured to determine a phonemic representation of the first audio input matches a phonemic representation of the audio name information.
